(19) United States
(12) Patent Application Publication
(10) Pub. No.: US 2025/0321594 A1
(43) Pub. Date: Oct. 16, 2025

(54) SYSTEMS AND METHODS FOR CONTROLLING A WATERCRAFT VIA PROPULSION DEVICES

(71) Applicant: Navico Group Americas, LLC, Menomonee Falls, WI (US)

(72) Inventor: Matthew W. Laster, Broken Arrow, OK (US)

(21) Appl. No.: 18/636,811

(22) Filed: Apr. 16, 2024

(51) Int. Cl. G05D 1/65; B63H 21/21; G05D 1/223; G05D 109/30

(52) U.S. Cl. CPC G05D 1/65; B63H 21/21; G05D 1/223; G05D 2109/34

(57) ABSTRACT

A system for controlling a speed of a watercraft includes first and second propulsion devices configured to propel the watercraft, a processor, and a memory. The processor is configured to receive data indicating a desired speed of the watercraft, determine a first power input value for the first propulsion device and a second power input value for the second propulsion device such that a predicted speed of the watercraft equals the desired speed of the watercraft, and cause the first propulsion device to operate according to the first power input value and the second propulsion device to operate according to the second power input value such that the watercraft achieves the desired speed. The predicted speed of the watercraft corresponds to when the first propulsion device is operating according to the first power input value and the second propulsion device is operating according to the second power input value.

### FIELD

Example embodiments of the present invention generally relate to propulsion devices associated with watercrafts and, more particularly to controlling multiple propulsion devices on a same watercraft.

### BACKGROUND

Many watercrafts used today have more than one propulsion device, and those propulsion devices are controlled individually. For example, a user may use a steering wheel and/or a throttle to control an outboard motor on a watercraft and then may use a separate mechanism to control a trolling motor that is attached to the same watercraft. In many situations, it is desirable to use multiple propulsion devices at the same time to achieve a certain result. For example, it might be desirable to use an outboard motor and a trolling motor at the same time to, e.g., have more control over the bow and stern of a watercraft during a certain activity such as fishing. Currently, a user has to give separate instructions to an outboard motor and to a trolling motor when both are being used on a same watercraft. This can be cumbersome and time consuming in situations that may be fast paced because it requires the user to make two separate decisions, complete two separate tasks, and sometimes even move from a first place on the watercraft to a second place on the watercraft.

Improvements in the foregoing are desired.

### BRIEF SUMMARY

The systems and methods disclosed herein are for controlling a speed and/or a direction of a watercraft. In some embodiments, a watercraft has first and second propulsion devices that are in communication with a processor, and the processor is configured to determine input values for the first and second propulsion devices such that the watercraft as a whole achieves a desired speed and/or direction. Further, in some embodiments, the processor may also be in communication with a joystick that can receive user input that indicates the desired speed and/or direction. The instructions determined by the processor and sent to the first and second propulsion devices are configured such that the watercraft as a whole travels at the desired speed and/or direction.

Such systems and methods are useful in that they eliminate the need for a user to determine and give different instructions to different propulsion devices on a watercraft. For example, instead of a user having to use a steering wheel and throttle to direct an outboard motor in one speed and direction and then separately using a remote to set another speed and direction of a trolling motor in hopes of achieving an overall maneuvering of a watercraft, the user can simply provide input indicating a desired maneuvering of the watercraft, and the processor will determine optimal instructions for the propulsion devices accordingly such that the desired maneuvering of the watercraft is achieved. This eliminates time-consuming and mentally cumbersome tasks that are often obstacles to users participating in time sensitive activities such as fishing or docking.

Some example embodiments of the disclosure may include any number of propulsion devices, and the instructions determined for such propulsion devices may be optimized by the processor for various outcomes. For example, the processor may be configured to cause different optimizations depending on weather conditions, user activities, battery life of certain components on the watercraft, user preference, or any other factors. In some further embodiments, machine learning methods may be used to perform such optimizations.

In an example embodiment, a system for controlling a speed of a watercraft is provided. The system includes a first propulsion device configured to propel the watercraft, a second propulsion device configured to propel the watercraft, a processor, and a memory including computer program code configured to, when executed, cause the processor to receive data indicating a desired speed of the watercraft and determine a first power input value for the first propulsion device and a second power input value for the second propulsion device such that a predicted speed of the watercraft equals the desired speed of the watercraft. The first power input value is a non-zero value, the second power input value is a non-zero value, and the predicted speed of the watercraft corresponds to when the first propulsion device is operating according to the first power input value and the second propulsion device is operating according to the second power input value. The memory also includes computer program code configured to, when executed, cause the processor to cause the first propulsion device to operate according to the first power input value and the second propulsion device to operate according to the second power input value such that the watercraft achieves the desired speed.

In some embodiments, the first propulsion device may be a trolling motor.

In some embodiments, the second propulsion device may be an outboard or an inboard motor.

In some embodiments, the system may further include a third propulsion device, and the processor may be further configured to determine the first power input value for the first propulsion device, the second power input value for the second propulsion device, and a third power input value for the third propulsion device such that the predicted speed of the watercraft equals the desired speed of the watercraft. The predicted speed of the watercraft may correspond to when the first propulsion device is operating according to the first power input value, the second propulsion device is operating according to the second power input value, and the third propulsion device is operating according to the third power input value. The processor may also be further configured to cause the first propulsion device to operate according to the first power input value, the second propulsion device to operate according to the second power input value, and the third propulsion device to operate according to the third power input value such that the watercraft achieves the desired speed.

In some embodiments, the third propulsion device may be a thruster.

In some embodiments, the data indicating the desired speed of the watercraft may come from at least one of a remote, a joystick, or a mobile device.

In some embodiments, the processor may be further configured to do at least one of: receive first data from the first propulsion device indicating at least one of a first direction of the first propulsion device, a first detected revolutions per minute value of the first propulsion device, or a first status of the first propulsion device; receive second data from the second propulsion device indicating at least one of a second direction of the second propulsion device, a second detected revolutions per minute value of the second propulsion device, or a second status of the second propulsion device; or receive additional data from at least one of the first propulsion device, the second propulsion device, a marine electronics device on the watercraft, or a remote server.

In some embodiments, the first status may be at least one of a first on/off status or a first operating mode, and the second status may be at least one of a second on/off status or a second operating mode.

In some embodiments, the processor may be further configured to use at least one of the first data, the second data, or the additional data to determine the first power input value for the first propulsion device and the second power input value for the second propulsion device.

In some embodiments, the processor may be further configured to use at least one of the first data, the second data, or the additional data to determine at least one of a first new direction for the first propulsion device or a second new direction for the second propulsion device.

In some embodiments, the processor may be further configured to use machine

learning methods for at least one of determining the first power input value for the first propulsion device and the second power input value for the second propulsion device or determining at least one of the first new direction for the first propulsion device or the second new direction for the second propulsion device.

In some embodiments, the additional data may include at least one of battery life data for at least one of the first propulsion device or the second propulsion device, depth data, tide data, wind data, weather data, boat profile data, or user defined data.

In some embodiments, the processor may be further configured to detect a partial loss or a full loss of output in at least one of the first propulsion device or the second propulsion device and dynamically update the first power input value for the first propulsion device and the second power input value for the second propulsion device such that the watercraft maintains the desired speed.

In some embodiments, the data indicating the desired speed of the watercraft may include at least one of user input, a signal from an autopilot navigation assembly, or a signal from the processor.

In some embodiments, the processor may be further configured to determine a mode in which the watercraft is operating and use the mode to determine the first power input value for the first propulsion device and the second power input value for the second propulsion device.

In some embodiments, the mode may be at least one of a fishing mode, a cruising mode, a trolling mode, a docking mode, a rough conditions mode, a low battery mode, a low fuel mode, or a customized mode.

In some embodiments, the processor may be further configured to receive data indicating a desired direction of the watercraft, determine first instructions that include a first vector associated with the first propulsion device, determine second instructions that include a second vector associated with the second propulsion device, and cause the first propulsion device to operate according to the first instructions. The first vector may correspond to the first power input value such that causing the first propulsion device to operate according to the first instructions also causes the first propulsion device to operate according to the first power input value. The processor may also be further configured to cause the second propulsion device to operate according to the second instructions. The second vector may correspond to the second power input value such that causing the second propulsion device to operate according to the second instructions also causes the second propulsion device to operate according to the first power input value.

In some embodiments, the first instructions that include the first vector may include a first direction and the first power input value, and the second instructions that include the second vector may include a second direction and the second power input value. The first instructions and the second instructions may be determined such that the watercraft as a whole travels at the desired speed and in the desired direction when the first propulsion device operates according to the first instructions and the second propulsion device operates according to the second instructions.

In another example embodiment, a method for controlling a speed of a watercraft is provided. The method includes receiving data indicating a desired speed of the watercraft and determining a first power input value for a first propulsion device and a second power input value for a second propulsion device such that a predicted speed of the watercraft equals the desired speed of the watercraft. The first propulsion device is configured to propel the watercraft, and the second propulsion device is configured to propel the watercraft. The first power input value is a non-zero value, the second power input value is a non-zero value, and the predicted speed of the watercraft corresponds to when the first propulsion device is operating according to the first power input value and the second propulsion device is operating according to the second power input value. The method also includes causing the first propulsion device to operate according to the first power input value and the second propulsion device to operate according to the second power input value such that the watercraft achieves the desired speed.

In another example embodiment, a system for controlling a watercraft is provided. The system includes a first propulsion device configured to propel the watercraft, a second propulsion device configured to propel the watercraft, a control device configured to control at least one of an actual speed or an actual direction of the watercraft by communicating with at least the first propulsion device and the second propulsion device, a processor, and a memory including computer program code configured to, when executed, cause the processor to receive information from at least one of the first propulsion device or the second propulsion device including at least one of: one or more of a first direction of the first propulsion device and a second direction of the second propulsion device; one or more of a first revolutions per minute value of the first propulsion device and a second revolutions per minute value of the second propulsion device; or one or more of a first status of the first propulsion device and a second status of the second propulsion device. The memory also includes computer program code configured to, when executed, cause the processor to receive data from the control device indicating at least one of a desired direction or a desired speed of the watercraft, automatically determine instructions to send to each of the first propulsion device and the second propulsion device to achieve the at least one of the desired direction or the desired speed of the watercraft, and cause the first propulsion device and the second propulsion device to operate according to the instructions such that the at least one of the actual speed or the actual direction of the watercraft is equal to the at least one of the desired speed or the desired direction of the watercraft, respectively.

In another example embodiment, a method for controlling a watercraft is provided. The method includes receiving information from at least one of a first propulsion device or a second propulsion device. The first propulsion device is configured to propel the watercraft, and the second propulsion device is configured to propel the watercraft. The information includes at least one of: one or more of a first direction of the first propulsion device and a second direction of the second propulsion device; one or more of a first revolutions per minute value of the first propulsion device and a second revolutions per minute value of the second propulsion device; or one or more of a first status of the first propulsion device and a second status of the second propulsion device. The method also includes receiving data from a control device indicating at least one of a desired direction or a desired speed of the watercraft. The control device is configured to control at least one of an actual speed or an actual direction of the watercraft by communicating with at least the first propulsion device and the second propulsion device. The method also includes automatically determining instructions to send to each of the first propulsion device and the second propulsion device to achieve the at least one of the desired direction or the desired speed of the watercraft and causing the first propulsion device and the second propulsion device to operate according to the instructions such that the at least one of the actual speed or the actual direction of the watercraft is equal to the at least one of the desired speed or the desired direction of the watercraft, respectively.

In another example embodiment, a system for controlling a watercraft is provided. The system includes a joystick configured to receive user input indicating at least one of a desired direction or a desired speed of the watercraft, the watercraft, a first propulsion device configured to propel the watercraft, a second propulsion device configured to propel the watercraft, a processor, and a memory including computer program code configured to, when executed, cause the processor to receive data from the joystick indicating the at least one of the desired direction or the desired speed of the watercraft, determine first instructions that include a first vector associated with the first propulsion device, determine second instructions that include a second vector associated with the second propulsion device, cause the first propulsion device to operate according to the first instructions, and cause the second propulsion device to operate according to the second instructions. The first instructions and the second instructions are determined such that the watercraft as a whole travels at the at least one of the desired direction or the desired speed when the first propulsion device operates according to the first instructions and the second propulsion device operates according to the second instructions.

In some embodiments, the processor may optimize the first vector and the second vector based on additional data such that a desired efficiency is achieved when the processor causes the first propulsion device to operate according to the first instructions and the second propulsion device to operate according to the second instructions such that the watercraft as a whole travels at the at least one of the desired direction or the desired speed.

In some embodiments, the additional data may include at least one of battery life data, depth data, tide data, wind data, weather data, boat profile data, or user defined data.

In some embodiments, the processor may optimize the first vector and the second vector according to a mode in which the watercraft is operating.

In some embodiments, the mode may be at least one of a fishing mode, a cruising mode, a trolling mode, a docking mode, a rough conditions mode, a low battery mode, a low fuel mode, or a customized mode.

In some embodiments, the processor may be connected to the joystick.

In some embodiments, the processor may be connected to a marine electronic device on or near the watercraft.

In some embodiments, the processor may be within a mobile device.

In some embodiments, at least one of the first propulsion device or the second propulsion device may be a trolling motor.

In some embodiments, at least one of the first propulsion device or the second propulsion device may be an inboard or an outboard motor.

In some embodiments, at least one of the first propulsion device or the second propulsion device may be thruster.

In some embodiments, the joystick may be integrated into a mobile device.

In some embodiments, the joystick may be positioned on or in a remote.

In some embodiments, the joystick may be mounted to the watercraft.

In some embodiments, the joystick may be configured to be selectively lockable in a desired position such that, when the joystick is locked, the watercraft as a whole continuously travels at the at least one of the desired direction or the desired speed without user interaction.

In another example embodiment, a method for controlling a watercraft is provided. The method includes receiving data from a joystick indicating at least one of a desired direction or a desired speed of the watercraft and determining first instructions that include a first vector associated with a first propulsion device. The first propulsion device is configured to propel the watercraft. The method also includes determining second instructions that include a second vector associated with the second propulsion device. The second propulsion device is configured to propel the watercraft. The method also includes causing the first propulsion device to operate according to the first instructions and causing the second propulsion device to operate according to the second instructions. The first instructions and the second instructions are determined such that the watercraft as a whole travels at the at least one of the desired direction or the desired speed when the first propulsion device operates according to the first instructions and the second propulsion device operates according to the second instructions.

In another example embodiment, a system for controlling a watercraft is provided. The system includes a joystick configured to receive user input indicating at least one of a desired direction or a desired speed of the watercraft, the watercraft, a first propulsion device configured to propel the watercraft, and a second propulsion device configured to propel the watercraft. In response to receiving the user input, the joystick is configured to send a signal to at least one of a component associated with the watercraft, the first propulsion device, or the second propulsion device, and the signal causes the watercraft as a whole to travel at the at least one of the desired direction or the desired speed.

In some embodiments, the system may further include a processor and a memory including computer program code configured to, when executed, cause the processor to determine a first vector associated with the first propulsion device and determine a second vector associated with the second propulsion device.

In some embodiments, the joystick may be configured to send the signal to the processor, and, in response to receiving the signal, the processor may be configured to send first instructions containing the first vector to the first propulsion device and second instructions containing the second vector to the second propulsion device. The first propulsion device may be configured to operate according to the first instructions when the first propulsion device receives the first instructions, and the second propulsion device may be configured to operate according to the second instructions when the second propulsion device receives the second instructions, such that the signal being sent from the joystick causes the watercraft as a whole to travel at the at least one of the desired direction or the desired speed.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 illustrates an example watercraft with an outboard motor and a trolling motor, in accordance with some embodiments described herein;

FIG. 2A illustrates another example watercraft with a first propulsion device and a second propulsion device each operating according to vector inputs such that an overall vector output of the watercraft is achieved, in accordance with some embodiments discussed herein;

FIG. 2B illustrates the watercraft of FIG. 2A with the first propulsion device and the second propulsion device each operating according to different vector inputs such that a same overall vector output of the watercraft is achieved, in accordance with some embodiments discussed herein;

FIG. 3A illustrates an example control device with a joystick receiving an overall vector input, in accordance with some embodiments discussed herein;

FIG. 3B illustrates the watercraft of FIG. 2A with the first propulsion device and the second propulsion device each operating according to vector inputs such that the vector output of the watercraft equals the overall vector input of FIG. 3A, in accordance with some embodiments discussed herein;

FIG. 3C illustrates the watercraft of FIG. 3B with the first propulsion device and the second propulsion device each operating according to different vector inputs such that the vector output of the watercraft equals the overall vector input of FIG. 3A, in accordance with some embodiments discussed herein;

FIG. 4A illustrates the control device of FIG. 3A with the joystick receiving another overall vector input, in accordance with some embodiments discussed herein;

FIG. 4B illustrates the watercraft of FIG. 2A with the second propulsion device operating according to a vector input and the first propulsion device not operating such that the vector output of the watercraft equals the overall vector input of FIG. 4A, in accordance with some embodiments discussed herein;

FIG. 5A illustrates the watercraft of FIG. 2A with the first propulsion device, the second propulsion device, a third propulsion device, and a fourth propulsion device each operating according to vector inputs such that an overall vector output of the watercraft is achieved, in accordance with some embodiments discussed herein;

FIG. 5B illustrates the watercraft of FIG. 5A with the first propulsion device, the second propulsion device, the third propulsion device, and the fourth propulsion device each operating according to different vector inputs such that a different overall vector output of the watercraft is achieved, in accordance with some embodiments discussed herein;

FIG. 6 illustrates the watercraft of FIG. 2A with the first propulsion device and the second propulsion device each operating according to vector inputs such that a same overall vector output of the watercraft is achieved to overcome rough wave conditions, in accordance with some embodiments discussed herein;

FIG. 7 illustrates a flowchart of an example method of machine learning, in accordance with some embodiments discussed herein;

FIG. 8 is a block diagram of an example system, in accordance with some embodiments described herein;

FIG. 9 shows an example method for controlling a speed of a watercraft, in accordance with some embodiments discussed herein; and

FIG. 10 shows an example method for controlling a watercraft, in accordance with some embodiments discussed herein.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout.

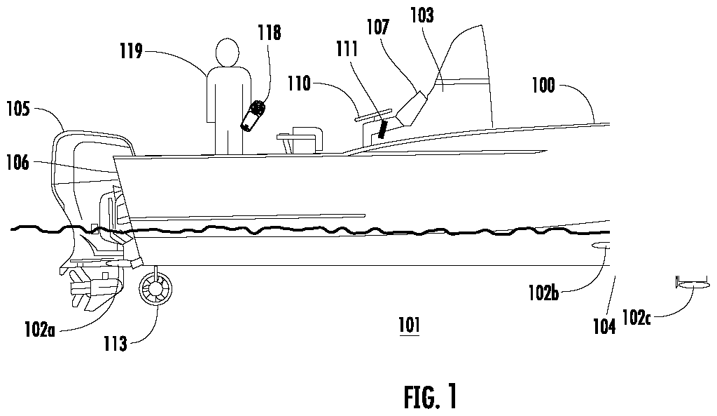

FIG. 1 illustrates a surface watercraft 100 on a body of water 101. The watercraft includes a marine electronic device 107 such as may be utilized by a user to interact with, view, or otherwise control various aspects of the watercraft and its various marine systems described herein. In the illustrated embodiment, the marine electronic device 107 is positioned proximate a console 103 of the watercraft 100—although other places on the watercraft 100 are contemplated. Likewise, additionally or alternatively, a user's mobile device may include functionality of a marine electronic device.

In some embodiments, the watercraft 100 may have a sonar transducer assembly disposed thereon. For example, a sonar transducer assembly 102b may be disposed on a hull 104 of the watercraft 100, and/or a sonar transducer assembly 102a may be disposed on a stern 106 of the watercraft 100. Further, one or more sonar transducers may be disposed anywhere else on the watercraft 100, such as sonar transducer assembly 102c on the trolling motor 108. The sonar transducer assemblies may be configured to transmit signals into the underwater environment and receive sonar return data generated by receipt of sonar return signals. A processor may then generate, based on the sonar return data, sonar image data corresponding to generation of at least one sonar image of the underwater environment. The sonar data and/or image(s) that are generated may then be displayed on a screen of a marine electronic device such as the marine electronic device 107.

Depending on the configuration, the watercraft 100 may include a main propulsion motor 105, such as an outboard or inboard motor, at, e.g., the stern 106 of the watercraft 100. Additionally, the watercraft 100 may include a trolling motor 108 configured to propel the watercraft 100 or maintain a position. The motor 105 and/or the trolling motor 108 may be steerable using a steering wheel 110, or in some embodiments, the watercraft 100 may have a navigation assembly that is operable to steer the motor 105 and/or the trolling motor 108. Similarly, the power inputs to the motor 105 and/or the trolling motor 108 may be controlled using a throttle 111, or in some embodiments, the navigation assembly may be operable to control the power input to the motor 105 and/or the trolling motor 108. The navigation assembly may be connected to a processor and/or be within a marine electronic device 107, or it may be located anywhere else on the watercraft 100. Alternatively, it may be located remotely.

In some embodiments, the watercraft 100 may also have thrusters such as thruster 113, which is located at the stern 106 of the watercraft 100. The thruster 113 may be controlled via the marine electronic device 107 or any other button or control device on the console 103. Additionally or alternatively, the thruster 113 may be controlled via a mobile device or by any other device on or near the watercraft 100. In some embodiments, the thruster 113 may be one of a pair of thrusters on either side of the stern 106 of the watercraft 100. In such embodiments, the pair of thrusters may be used to perform tasks such as aiding in docking the watercraft 100 and/or aiding in maneuvering the watercraft 100 in tight spaces, among other tasks.

The motor 105, trolling motor 108, thruster 113, and any other propulsion device(s) on the watercraft 100 may be connected to a central processor, which could be located anywhere, to control the entire watercraft 100. The central processor may, e.g., be located in the marine electronic device 107, in a mobile device, in a control device (such as remote 118), at a remote location, or anywhere else. The central processor may be configured, in some embodiments, to control and optimize power inputs to one or more of the propulsion devices (the motor 105, trolling motor 108, thruster 113, and/or any other propulsion device(s) on the watercraft 100) such that a final direction and/or speed of the entire watercraft 100 is achieved. In some embodiments, a control device such as the remote 118 may be usable by a user 119 to steer the entire watercraft 100, and the processor may be configured to receive those steering directions and subsequently direct all of the participating propulsion devices (the motor 105, trolling motor 108, thruster 113, and/or any other propulsion device(s) on the watercraft 100) to work together optimally to achieve the desired direction and/or speed indicated via, e.g., the remote 118, without further user input. The user 119 can therefore achieve an overall outcome of a desired direction and/or speed of the watercraft 100 without having to make complex and often time-consuming decisions as to which propulsion device (or combination of propulsion devices) would be best and without having to manually give directions to each of the propulsion devices that are needed for optimal performance.

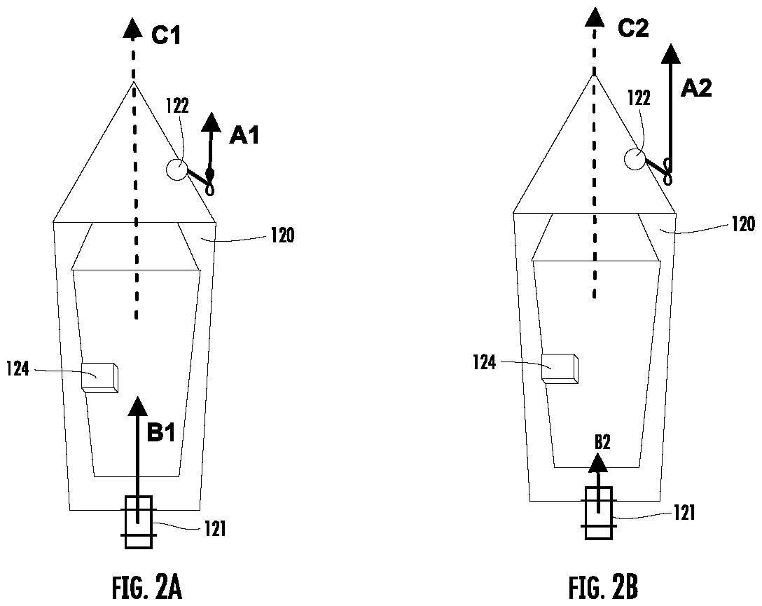

FIG. 2A illustrates a top view of a watercraft 120 configured to traverse a body of water. The watercraft 120 includes a console 124, which may include a marine electronic device or any other type of electronics and/or steering mechanism(s). The watercraft 120 also includes a first propulsion device 122 and a second propulsion device 121. In some embodiments, the first propulsion device 122 may be a trolling motor, and the second propulsion device 121 may be an inboard or outboard motor. In other embodiments, the first propulsion device 122 may be any other type of propulsion device, such as an inboard or outboard motor, thruster, etc., and the second propulsion device 121 may be any other type of propulsion device, such as a trolling motor, thruster, etc. Each of the first propulsion device 122 and the second propulsion device 121 are configured to propel the watercraft 120, and in some embodiments, the first propulsion device 122 and the second propulsion device 121 may be steerable.

The first propulsion device 122 and the second propulsion device 121 may be configured to coordinatively propel the watercraft 120 such that a first vector input A1 to the first propulsion device 122 and a second vector input B1 to the second propulsion device 121 combine to cause the watercraft 120 as a whole to travel according to an overall vector output C1. For example, a processor, which may be located in a marine electronic device of the console 124, in a control device, in a mobile device, at a remote location, or anywhere else, may be configured to receive data indicating a desired speed and/or direction of the watercraft 120 (e.g., corresponding to the overall vector output C1) and then determine a first power input value (e.g., first vector input A1) for the first propulsion device 122 and a second power input value (e.g., second vector input B1) for the second propulsion device 121. In some embodiments, these determinations may be made automatically. The processor may make this determination such that a predicted speed and/or direction of the watercraft equals the desired speed and/or direction of the watercraft (e.g., the overall vector output C1). The predicted speed of the watercraft may correspond to when the first propulsion device 122 is operating according to the first power input value and when the second propulsion device 121 is operating according to the second power input value. In some embodiments, the first power input value and the second power input value may be non-zero values. The processor may then cause the first propulsion device 122 to operate according to the first power input value and the second propulsion device 121 to operate according to the second power input value such that the watercraft 120 achieves the desired speed and/or direction (e.g., overall vector output C1).

As shown in FIG. 2A, the first vector input A1 of the first propulsion device 122 is slightly less than the second vector input B1 of the second propulsion device 121. This may be desirable for a variety of different reasons. For example, a user may want to preserve battery power being drawn by the first propulsion device 122 (e.g., a trolling motor) because the user has extra fuel onboard for the second propulsion device 121 (e.g., an outboard motor). Or, as another example, it may be desirable to use more power for the second propulsion device 121 (e.g., an outboard motor) than for the first propulsion device 122 (e.g., a trolling motor) at certain overall speeds, such as when the watercraft 120 is being moved from one fishing location to a second fishing location at a faster overall speed (e.g., compared to when trolling within the first or second fishing location, which a user might do at a slower overall speed). As shown in FIG. 2B, on the other hand, the first vector input A2 of the first propulsion device 122 is more than the second vector input B2 of the second propulsion device 121. Notably, the overall vector output C2 of the entire watercraft 120 in FIG. 2B is the same as the overall vector output C1 of the entire watercraft 120 in FIG. 2A. The only differences between FIGS. 2A and 2B are the vector inputs to each of the first propulsion device 122 and the second propulsion device 121. The scenario in FIG. 2B may be desirable for a variety of different reasons as well. For example, the user may be low on fuel and may therefore desire to use as little of the second propulsion device 121 (e.g., an outboard motor) as possible, in favor of the first propulsion device 122 (e.g., a trolling motor, which may be powered by battery rather than by gas). As another example, the user may be traveling through certain conditions in which a trolling motor is more desirable (e.g., shallower, hard to navigate waterways). Other examples are also contemplated within the scope of this disclosure.

In some embodiments, the processor may be configured to receive information from components such as the first propulsion device 122, the second propulsion device 121, a marine electronics device on the watercraft, a remote server, or any other component or device, and that information may be used by the processor in making certain determinations. For example, the processor may be additionally configured to receive first data from the first propulsion device 122 indicating, e.g., a first direction of the first propulsion device 122, a first detected revolutions per minute value of the first propulsion device 122, and/or a first status of the first propulsion device 122. Similarly, the processor may also be configured to receive second data from the second propulsion device 121 indicating, e.g., a second direction of the second propulsion device 121, a second detected revolutions per minute value of the second propulsion device 121, and/or a second status of the second propulsion device 121.

The processor may take into account the current speed and/or direction of each of the first propulsion device 122 and the second propulsion device 121 when making determinations for new vector inputs (e.g., for first vector input A1 and second vector input B1 in FIG. 2A or for first vector input A2 and second vector input B2 in FIG. 2B). The processor may also be able to take into account statuses of the first propulsion device 122 and the second propulsion device 121 when making such determinations. The first and second statuses may be, for example, on/off statuses or operating modes. For example, the processor may be able to receive information from one or both of the first propulsion device 122 and/or the second propulsion device 121 indicating whether those devices are powered on or off and also indicating whether those devices are operating according to a certain operating mode. In some embodiments, for example, one or both of the first propulsion device 122 and/or the second propulsion device 121 may operate in a fishing mode, a cruising mode, a trolling mode, a docking mode, a rough conditions mode, a low battery mode, a low fuel mode, and/or a customized mode, among others.

Additionally or alternatively, the processor may be configured to receive additional data from the first propulsion device 122, second propulsion device 121, a marine electronics device on the watercraft, or a remote server. For example, additional data may include battery life data for the first propulsion device 122 or the second propulsion device 121, depth data, tide data, wind data, weather data, boat profile data, and/or user defined data, among others.

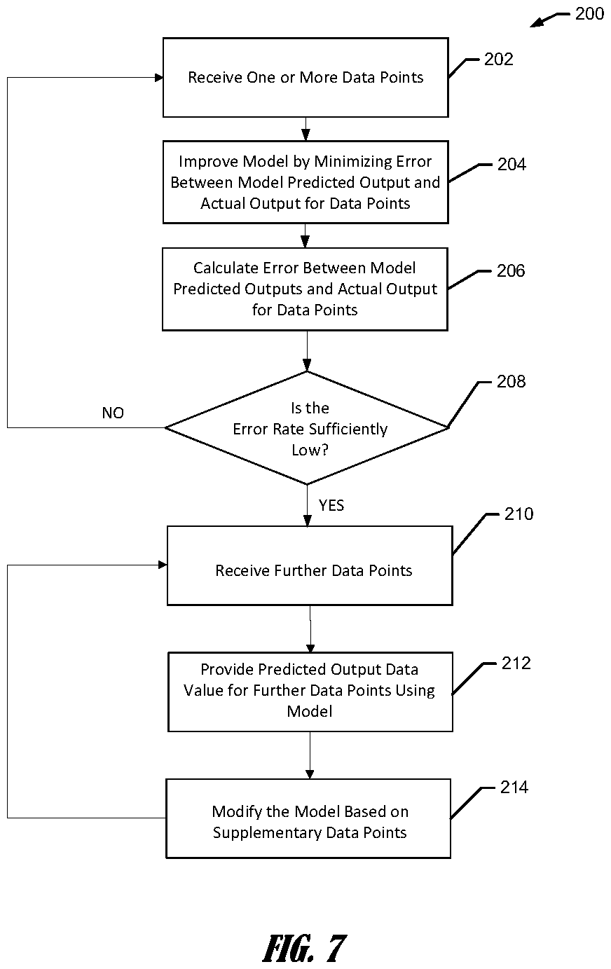

In some embodiments, the processor may be configured to use the first data from the first propulsion device 122, the second data from the second propulsion device 121, and/or the additional data to determine the first power input value (e.g., the first vector input A1 in FIG. 2A or the first vector input A2 in FIG. 2B) for the first propulsion device 122 and the second power input value (e.g., the second vector input B1 in FIG. 2A or the second vector input B2 in FIG. 2B) for the second propulsion device 121. Further, in some embodiments, the processor may also be configured to use the first data, the second data, and/or the additional data to determine a first new direction for the first propulsion device 122 and/or a second new direction for the second propulsion device 121. As described herein with reference to FIG. 7, machine learning methods may be used for any of these determinations. Alternatively, the processor may be pre-programmed to make such determinations. Other determination methods are also contemplated within the scope of this disclosure.

In some embodiments, the processor may be configured to determine a mode in which the watercraft 120 as a whole is operating. This may be obtained via, e.g., a marine electronic device on the watercraft, from a remote server, or from user input. The processor may use such determined mode to determine the first power input value for the first propulsion device 122 and the second power input value for the second propulsion device 121. The mode may be, for example, a fishing mode, a cruising mode, a trolling mode, a docking mode, a rough conditions mode, a low battery mode, a low fuel mode, and/or a customized mode, among others. For example, the processor may detect that the watercraft 120 as a whole is operating in a docking mode and therefore make a determination that relies more on a trolling motor, compared to a determination that would normally use the trolling motor less (such as in a rough conditions mode or a cruising mode). The use of the trolling motor during docking may help the watercraft maneuver more precisely and the knowledge that the watercraft 120 is being docked may help in making the determination of the vector input to apply to the trolling motor. Alternatively, as another example, the processor may detect that the watercraft 120 as a whole is operating in a cruising mode and therefore make a determination that relies more on an outboard motor at the stern of the watercraft 120, since the processor can predict that the bow portion of the watercraft 120 is likely to soon be too far out of the water for a trolling motor on the bow of the watercraft 120 to be of any help.

In some embodiments, the processor may be configured to operate in an efficiency mode. For example, the processor may be capable of operating in a fuel efficiency and/or an engine efficiency mode. This may involve making determinations for the vector inputs sent to the first propulsion device 122 and/or the second propulsion device 121 that primarily aim to conserve fuel and/or to conserve an integrity of engines onboard, respectively. For example, even if the processor would normally make a determination to operate with the outboard motor alone when the watercraft 120 is in a cruising mode, in a fuel efficiency mode, the processor may instead make a determination that incorporates use of a battery-powered trolling motor onboard in order to achieve a better fuel efficiency. The same result may occur when the processor is operating in an engine efficiency mode to ensure that one engine is not work significantly more than another. Other examples are also contemplated within the scope of this disclosure.

In some embodiments, as will be described in more detail herein, the watercraft 120 may include or be associated with a control device that is configured to control an actual speed and/or an actual direction of the watercraft by communicating with the first propulsion device 122 and/or the second propulsion device 121. In such embodiments, the processor may cause the first propulsion device 122 and the second propulsion device 121 to operate according to the instructions such that the actual speed and/or the actual direction of the watercraft 120 is equal to the desired speed and/or the desired direction of the watercraft 120, respectively.

Although not depicted in FIGS. 2A-2B, the watercraft 120 may include additional propulsion devices. For example, the watercraft 120 may include a third propulsion device, such as a thruster or any other type of propulsion device, and the processor may be configured to determine the first power input value for the first propulsion device 122, the second power input value for the second propulsion device 121, and a third power input value for the third propulsion device such that the predicted speed of the watercraft 120 equals the desired speed of the watercraft 120.

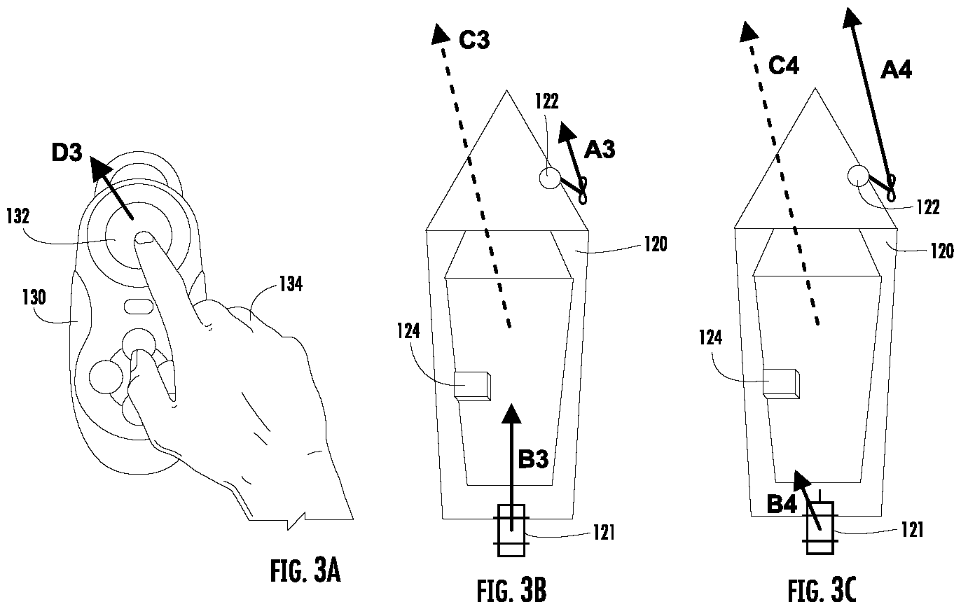

Referring now to FIGS. 3A-3C, some example systems may include a control device 130. The control device 130 depicted in FIG. 3A includes a joystick 132 that is configured to receive user input in the form of an overall vector input D3 from, e.g., a hand 134. It should be appreciated that, while the joystick 132 is integrated into the control device 130 in FIG. 3A, the joystick 132 may, in other embodiments, be integrated into a mobile device, mounted to a watercraft, or located anywhere else. The overall vector input D3 inputted using joystick 132 may indicate a desired speed and/or direction of the watercraft 120. As shown in FIGS. 3B-3C, a processor connected to the control device 130 (and/or the joystick 132), the first propulsion device 122, and the second propulsion device 121 may be configured to receive data from the control device 130 indicating the desired speed and/or direction corresponding to the overall vector input D3. The processor may then determine first instructions for the first propulsion device 122 and second instructions for the second propulsion device 121 such that the watercraft 120 as a whole travels at the desired speed and/or direction when the first propulsion device 122 operates according to the first instructions and the second propulsion device 121 operates according to the second instructions. The first instructions may include a first vector, and the second instructions may include a second vector. For example, the first instructions in FIG. 3B include first vector input A3, and the first instructions in FIG. 3C include first vector input A4. Similarly, the second instructions in FIG. 3B include second vector input B3, and the second instructions in FIG. 3C include second vector input B4. The processor may then cause the first propulsion device 122 and the second propulsion device 121 to operate according to the first instructions and the second instructions, respectively, such that the watercraft 120 as a whole travels at the desired speed and/or direction indicated by the overall vector input D3. For example, in FIG. 3B, the overall vector output C3 of the entire watercraft 120 matches (or at least corresponds to) the overall vector input D3, and in FIG. 3C, the overall vector output C4 of the entire watercraft 120 also matches (or at least corresponds to) the overall vector input D3.

Said differently, in response to receiving the user input, the joystick 132 may be configured to send a signal to component(s) associated with the watercraft 120, the first propulsion device 122, and/or the second propulsion device 121. The signal may cause the watercraft 120 as a whole to travel at the desired speed and/or direction. For example, the joystick 132 may be configured to send the signal to the processor, and, in response to receiving the signal, the processor may be configured to send first instructions containing the first vector to the first propulsion device 122 and second instructions containing the second vector to the second propulsion device 121. Accordingly, the first propulsion device 122 may be configured to operate according to the first instructions when the first propulsion device 122 receives the first instructions, and the second propulsion device 121 may be configured to operate according to the second instructions when the second propulsion device 121 receives the second instructions.

Notably, different optimizations may take place for the same overall output vector. That is, for the same values for the overall input vector D3, overall output vector C3, and overall output vector C4 in FIGS. 3A-3C, there may be different values for the first vector input A3, second vector input B3, first vector input A4, and second vector input B4. Such different optimizations may occur for a variety of different reasons. For example, in FIG. 3B, the first vector input A3 is less powerful than the second vector input B3 and is turned in the desired direction more than is the second vector input B3. This may be optimal in certain conditions, such as when moving the watercraft 120 at higher speeds when a user is not fishing or trolling, and/or when the user wants the watercraft 120 to move in a generally forward direction with only an occasional turn that need not be precise (e.g., when moving faster through a body of water to move from a first fishing location to a second fishing location). Alternatively, in FIG. 3C, the first vector input A4 is more powerful than is the second vector input B4, and both the first vector input A4 and the second vector input B4 are turned in the desired direction. This may be optimal in certain conditions, such as when a user is fishing/trolling at low speeds, and/or when the user wants to move in a generally forward direction while also being able to maneuver precisely through tight spaces (e.g., when moving slower through a body of water at a first fishing location, which may have a narrow and winding path, while multiple fishing lines are rigged from the watercraft 120). Such optimizations may be achieved through the processor detecting certain settings on a marine electronic device, received user input indicating optimization preference(s), or otherwise. Further, in some embodiments, machine learning methods may be used, as described herein with reference to FIG. 7.

In some embodiments, the processor may optimize the first vector (e.g., first vector input A3 or first vector input A4) and the second vector (e.g., second vector input B3 or second vector input B4) based on additional data such that a desired efficiency is achieved when the processor causes the first propulsion device 122 to operate according to the first instructions and the second propulsion device 121 to operate according to the second instructions. The additional data may include, for example, battery life data, depth data, tide data, wind data, weather data, boat profile data, and/or user defined data, among other types of data. Further, in some other embodiments, the processor may optimize the first vector (e.g., first vector input A3 or first vector input A4) and the second vector (e.g., second vector input B3 or second vector input B4) according to a mode in which the watercraft 120 is operating. For example, the mode may be a fishing mode, a cruising mode, a trolling mode, a docking mode, a rough conditions mode, a low battery mode, a low fuel mode, and/or a customized mode, among others. Any of these optimizations/determinations made be made using machine learning methods, as described herein with reference to FIG. 7. Alternatively, the processor may be pre-programmed to make such optimizations/determinations. Other optimization/determination methods are also contemplated within the scope of this disclosure.

Referring back to FIG. 3A, in some embodiments, the joystick 132 may be configured to be selectively lockable in a desired position such that, when the joystick 132 is locked, the watercraft as a whole continuously travels at the desired speed and/or direction without user interaction. For example, if a user wants to travel from a first fishing location to a second fishing location, across an open body of water with little to no obstacles, the user may lock the joystick 132 in the position shown in FIG. 3A for a period of time. This may enable the user to instruct the watercraft to travel along a diagonal path for a period of time without the user's hand 134 having to remain on the joystick 132 for that entire period of time.

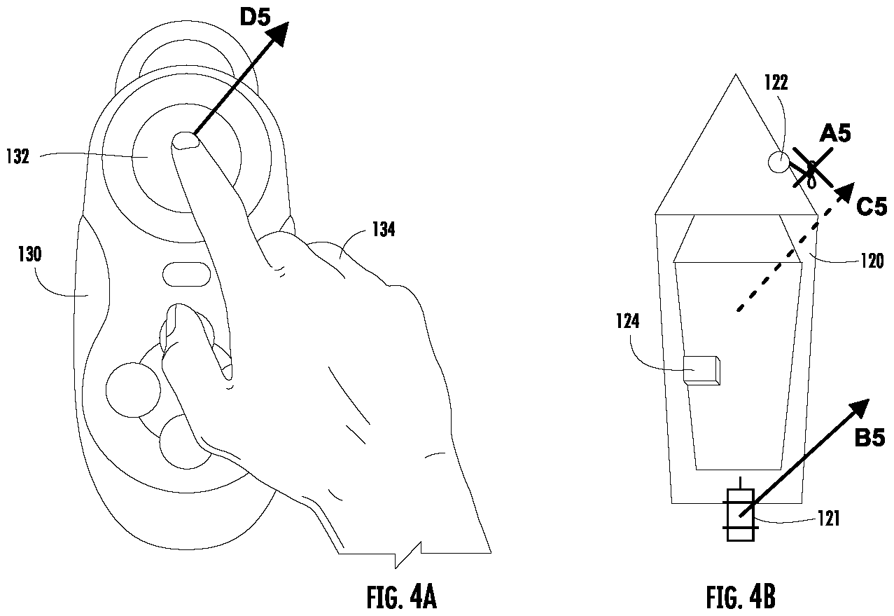

Referring now to FIGS. 4A-4B, optimizations may eliminate use of a propulsion device altogether when certain conditions and/or circumstances are detected. For example, in the situation shown in FIGS. 4A-4B in which the joystick 132 is pushed by the hand 134 to indicate an overall input vector D5, the processor may respond as shown in FIG. 4B by providing a first vector input A5 of zero and a second vector input B5 that is equal to the overall vector input D5 such that an overall vector output C5 (that is consistent with the overall input vector D5) is achieved. The processor might respond in this way, e.g., in situations in which conditions are too rough for the first propulsion device 122 to operate. In embodiments in which the first propulsion device 122 is equipped with auto-stow capabilities, the processor may even cause the first propulsion device 120 to be auto-stowed. As another example, the processor may determine that the first propulsion device 122 is simply not necessary for the detected task (e.g., the processor may determine that the watercraft 120 is moving at fast speeds, with a low frequency of any directional changes). Other examples are also contemplated within the scope of this disclose. Further, for different reasons, the processor may alternatively respond by providing a second vector input B5 of zero and a first vector input A5 that is equal to the overall vector input D5 such that the overall vector output C5 is achieved.

Further, the processor may also be configured to detect a partial loss or a full loss of output in the first propulsion device 122 and/or the second propulsion device 121 and then dynamically update the first vector input for the first propulsion device 122 and the second vector input for the second propulsion device 121 such that the watercraft 120 maintains the desired speed and/or direction. For example, in a situation in which the first propulsion device 122 is a trolling motor that is battery-powered, the processor may give initial instructions that include non-zero values for a first vector input and a second vector input that work together to achieve the overall vector output C5. The processor may then detect that battery power has been partially or fully lost in the first propulsion device 122 and then may dynamically (e.g., promptly or automatically) re-determine instructions to send to the first propulsion device 122 and/or the second propulsion device 121 to accommodate for the detected partial or full power loss. For example, in the example situation in which the processor gives initial instructions that include non-zero values for a first vector input and a second vector input that work together to achieve the overall vector output C5, the processor may later determine that power has been completely lost for the first propulsion device 122 and then send new instructions that include the first vector input A5 and the second vector input B5 that are shown in FIG. 4B (which also achieves the overall output vector C5 that corresponds to the overall input vector D5 of FIG. 4A). Other examples are also contemplated within the scope of this disclosure.

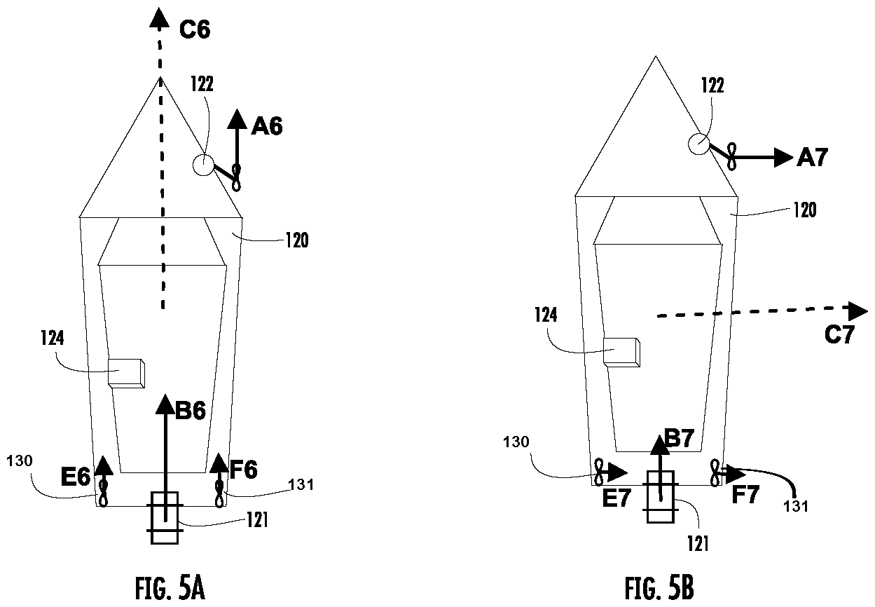

Referring now to FIGS. 5A-5B, the watercraft 120 may include a third propulsion device 130 and a fourth propulsion device 131. In some embodiments, the third propulsion device 130 and the fourth propulsion device 131 may be thrusters, but in other embodiments, the third propulsion device 130 and/or the fourth propulsion device 131 may be any other type of propulsion device. The processor may perform the same or similar tasks as described with respect to embodiments having only two propulsion devices, except for in these embodiments, the processor may consider four propulsion devices and send separate instructions/vector inputs to each. In FIG. 5A, for example, the processor is sending a first vector input A6 to the first propulsion device 122, a second vector input B6 to the second propulsion device 121, a third vector input E6 to the third propulsion device 130, and a third vector input F6 to the fourth propulsion device 131. All of the vector inputs shown in FIG. 5A (first vector input A6, second vector input B6, third vector input E6, and fourth vector input F6) are configured in a straight-forward direction such that a straightforward overall vector output C6 is achieved. As an example, the distribution of power shown in FIG. 5A may be optimal in moderate conditions in which the watercraft is traversing a body of water at moderate speeds.

FIG. 5B, on the other hand, shows three of the vector inputs (first vector input A7, third vector input E7, and fourth vector input F7) in a side-facing direction, with the second vector input B7 being barely directed in a straightforward direction, such that a generally side-facing overall vector output C7 is achieved. This may be optimal in a docking situation, in which precise control over the watercraft 120 is necessary as the watercraft 120 approaches a dock. The added third propulsion device 130 and fourth propulsion device 1313, which may be thrusters, provide even more precision to the stern of the watercraft 120, while the first propulsion device 122 is capable of controlling the bow of the watercraft 120. The second propulsion device 121 may still be helpful in this scenario as well, by slowly pushing the watercraft in a forward direction as the watercraft 120 approaches the dock. Notably, the processor is able to optimize all four of the propulsion devices on the watercraft 120 with little to no input from the user. This is a vast improvement from current systems, which require the user to make decisions for each of the propulsion devices sometimes in a matter of seconds. Because of this, even the most advanced users might not be able to succeed on their first try (e.g., docking the watercraft 120 in rough currents). The current disclosure provides a consistent way for even the most novice user to perform difficult maneuvers such as docking the watercraft 120 in rough currents.

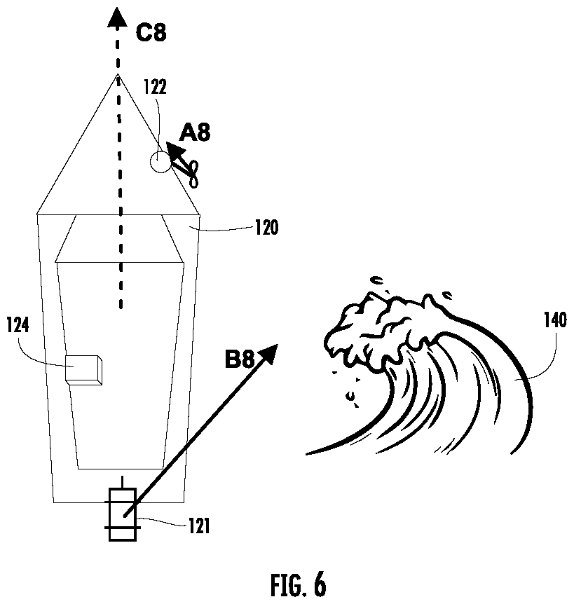

Referring now to FIG. 6, the processor may be configured to cause the first propulsion device 122 and the second propulsion device 121 to work in different directions in order to achieve a steady overall orientation in, e.g., rough conditions. For example, as shown in FIG. 6, rough wave conditions 140 may cause different portions of the watercraft 120 to experience different extreme effects. The processor may detect such rough wave conditions 140 and determine instructions to send to the first propulsion device 122 and the second propulsion device 121 that aim to keep the watercraft 100 as steady and/or stable as possible and aim to prevent damage to one or both of the first propulsion device 122 and the second propulsion device. For instance, if the first propulsion device 122 is a trolling motor and the second propulsion device 121 is an outboard motor, the processor may determine and/or have predetermined that the trolling motor is more susceptible to damage in rough conditions. The processor may therefore instruct the first propulsion device 122 (trolling motor) to operate in a direction that is complicit with (e.g., in the same direction of) the rough wave conditions 140, along first vector input A8, while simultaneously instructing the second propulsion device 121 (outboard motor) to operate in a direction that is at least partially against the rough wave conditions 140, along second vector input B8, to achieve an overall vector output C8 that withstands the rough wave conditions 140. This may be different than a response that fails to account for the fragility of the first propulsion device 122, which might employ both the first propulsion device 122 and the second propulsion device 121 in directions that are against the rough wave conditions 140 to achieve the greatest effect (but while risking damage to the first propulsion device 122). Additional factors may be considered as well that may further affect vector input determinations, such as speed, wind, current, or any other factor.

### Example Use of Artificial Intelligence

FIG. 7 is a flowchart of an example method 200 of machine learning, such as may be utilized with artificial intelligence for various embodiments of the present invention. At least one processor or another suitable device may be configured to develop a model for, e.g., the determination of instructions and/or input values to send to propulsion devices on a watercraft to optimize an overall speed and/or direction of the watercraft, among other determinations, such as described herein in various embodiments. In this regard, the developed model may be deployed and utilized to determine instructions and/or input values to send to propulsion devices on a watercraft to optimize an overall speed and/or direction of the watercraft, for a processor, such as described herein. Other determinations may also be made using the developed model as well, as described and referred to herein. In some embodiments, for example, a marine electronic device and/or a control device may comprise one or more processors that perform the functions shown in FIG. 7.

This system may beneficially determine instructions and/or input values to send to propulsion devices on a watercraft to optimize an overall speed and/or direction of the watercraft by accounting for different types of marine data, as well as additional data that may come from external sources (e.g., weather data, detected activity settings, upcoming sea floor information, navigation information, etc.), and the developed model may assign different weights to different types of data that are provided. In some systems, even after the model is deployed, the systems may beneficially improve the developed model by analyzing further data points. By utilizing artificial intelligence, a novice user may benefit from the experience of the models utilized, making marine activities more user friendly and accessible/successful for beginners. Embodiments beneficially allow for instructions and/or input values to be sent to propulsion devices on a watercraft to optimize an overall speed and/or direction of the watercraft without a user having to make manual decisions or inferences related to factors such as the weather, the activity, the battery life of certain component son the watercraft, among other things. Utilization of the model may prevent the need for a user to spend a significant amount of time reviewing information, freeing the user to perform other tasks and enabling performance and consideration of complex estimations and computations that the user could not otherwise solve on their own (e.g., the systems described herein may also be beneficial for even the most experienced users). Further, utilization of the model may enable a novice user who would otherwise not know how to optimize use of multiple propulsion devices on a watercraft to use multiple propulsion devices for sophisticated purposes such as docking the watercraft, fishing, or navigating rough conditions (among other purposes).

By receiving several different types of data, the example method 200 may be performed to generate complex models. The example method 200 may find relationships between different types of data that may not have been anticipated. By detecting relationships between different types of data, the method 200 may generate accurate models even where a limited amount of data is available.

In some embodiments, the model may be continuously improved even after the model has been deployed. Thus, the model may be continuously refined based on changes in the systems or in the environment over time, which provides a benefit as compared with other models that stay the same after being deployed. The example method 200 may also refine the deployed model to fine-tune weights that are provided to various types of data based on subtle changes in the watercraft and/or the environment. Where certain parts of the watercraft are replaced, modified, or damaged or where there are swift changes in the environment, the method 200 may continuously refine a deployed model to quickly account for the changes and provide a revised model that is accurate. By contrast, where a model is not continuously refined, changes to the watercraft or the surrounding environment may make the model inaccurate until a new model may be developed and implemented, and implementation of a new model may be very costly, time-consuming, and less accurate than a continuously refined model.

At operation 202, one or more data points are received. These data points preferably comprise known data from, e.g., preferred sea floor data, a preferred depth or depth range, a preferred range of image characteristics, or some other indication that the model may be used to predict. For example, where the model is being generated to determine instructions and/or input values to send to propulsion devices on a watercraft to optimize an overall speed and/or direction of the watercraft, the data points provided at operation 202 preferably comprises known data that corresponds to each propulsion device along with other known data such as known sea floor information, navigation information, weather information, current information, activity information, and/or battery level information, among others. The data points may take the form of discrete data points. However, where the data points are not known at a high confidence level, a calculated data value may be provided, and, in some cases, a standard deviation or uncertainty value may also be provided to assist in determining the weight to be provided to the data value in generating a model. In this regard, the model predicted instructions and/or input values may be formed based on historical comparisons of data.

For example, the model may be formed based on historical comparisons of various forms of current information with historical data, and a processor may be configured to utilize the developed model to determine an estimated recommendation for instructions and/or input values based on determined flexibilities, criticalities, and other assessments of the various types of condition parameters. This model may be developed through machine learning utilizing artificial intelligence based on the historical comparisons of the historical data associated with each of the input values being considered, among other information from external data sources. Alternatively, a model may be developed through artificial intelligence, and the model may be formed based on historical comparisons of the data and additional data. A processor may be configured to use the model and input the data into the model to determine the recommendation for the instructions and/or input values that should be sent to the propulsion devices on the watercraft to achieve the overall desired speed and/or direction of the watercraft.

Another example of appropriate historical comparisons may include comparing additional data (e.g., geographical data from maps or nautical charts, temperature data, time data, etc.) with sea floor data. Additional data may be provided from a variety of sources, and additional data may, for example, be provided from a camera, a radar, a thermometer, a clock, a pressure sensor, a direction sensor, or a position sensor.

At operation 204, a model is improved by minimizing error between a predicted output generated by the model and an actual output for data points. In some embodiments, an initial model may be provided or selected by a user. The user may provide a hypothesis for an initial model, and the method 200 may improve the initial model. However, in other embodiments, the user may not provide an initial model, and the method 200 may develop the initial model at operation 204, such as during the first iteration of the method 200. The process of minimizing error may be similar to a linear regression analysis on a larger scale where three or more different variables are being analyzed, and various weights may be provided for the variables to develop a model with the highest accuracy possible. Where a certain variable has a high correlation with the actual output, that variable may be given increased weight in the model. For example, where data from maps or nautical charts are available, that data may be provided alongside with user input, and the model may be optimized to give the map data its appropriate weight. In refining the model by minimizing the error between the predicted output generated by the model and the actual or known output, the component performing the method 200 may perform a very large number of complex computations. Sufficient refinement results in an accurate model.

In some embodiments, the accuracy of the model may be checked. For example, at operation 206, the accuracy of the model is determined. This may be done by calculating the error between the model predicted output generated by the model and the actual output from the data points. In some embodiments, error may also be calculated before operation 204. By calculating the accuracy or the error, the method 200 may determine if the model needs to be refined further or if the model is ready to be deployed. Where the output is a qualitative value or a categorical value, the accuracy may be assessed based on the number of times the predicted value was correct. Where the output is a quantitative value, the accuracy may be assessed based on the difference between the actual value and the predicted value.

At operation 208, a determination is made as to whether the calculated error is sufficiently low. A specific threshold value may be provided in some embodiments. For example, where an output is a directional input value for a propulsion device, the threshold may be 1 degree, and the calculated error may be sufficiently low if the average error is less than or equal to 1 degree. However, other threshold values may be used, and the threshold value may be altered by the user in some embodiments. If the error rate is not sufficiently low, then the method 200 may proceed back to operation 202 so that one or more additional data points may be received. If the error rate is sufficiently low, then the method 200 proceeds to operation 210. Once the error rate is sufficiently low, the training phase for developing the model may be completed, and the implementation phase may begin where the model may be used to predict the expected output.

By completing operations 202, 204, 206, and 208, a model may be refined through machine learning utilizing artificial intelligence based on the historical comparisons of data and based on known deviations of the data for the historical comparisons. Notably, example model generation and/or refinement may be accomplished even if the order of these operations is changed, if some operations are removed, or if other operations are added.

During the implementation phase, the model may be utilized to provide optimal instructions (e.g., input values, signal(s), or any other type of instruction that can be sent to a propulsion device). An example implementation of a model is illustrated from operations 210-212. In some embodiments, the model may be modified (e.g., further refined) based on the received data points, such as at operation 214.

At operation 210, further data points are received. For these further data points, the output may not be known. At operation 212, the model may be used to provide a predicted output data value for the further data points. Thus, the model may be utilized to determine the output.

At operation 214, the model may be modified based on supplementary data points, such as those received during operation 210 and/or other data points. For example, the model may be refined utilizing the data and the determined output(s), such as described herein. By providing supplementary data points, the model can continuously be improved even after the model has been deployed. The supplementary data points may be the further data points received at operation 210, or the supplementary data points may be provided to the processor from some other source. In some embodiments, the processor(s) or other component performing the method 200 may receive additional data from secondary devices and verify the further data points received at operation 210 using this additional data. By doing this, the method 200 may prevent errors in the further data points from negatively impacting the accuracy of the model.

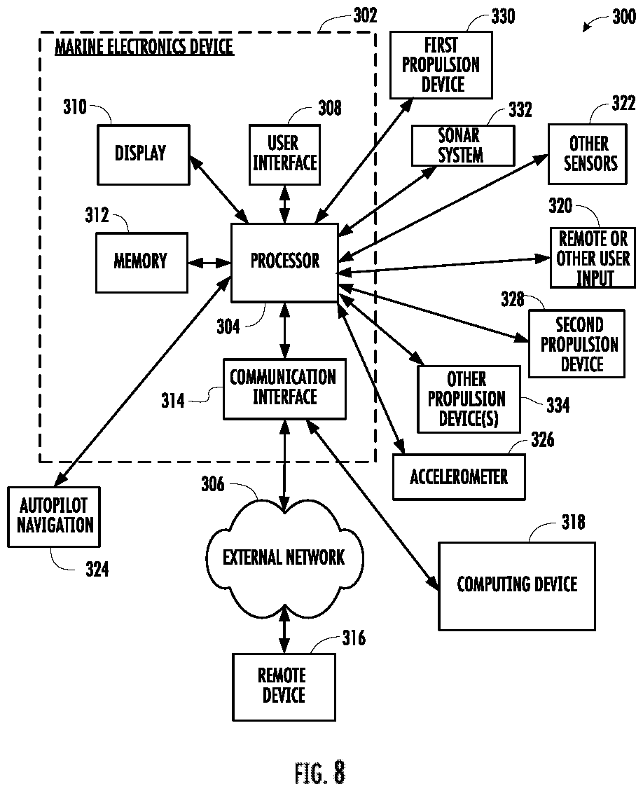

In some embodiments, supplementary data points are provided to the processor from some other source and are utilized to improve the model. For example, supplementary data points may be saved to a memory 312 (FIG. 8) associated with at least one processor 304 via communication interface 314, or the supplementary data points may be sent through the external network 306 from a remote device 316. These supplementary data points may be verified before being provided to the at least one processor 304 to improve the model, or the at least one processor 304 may verify the supplementary data points utilizing additional data.

As indicated above, in some embodiments, operation 214 is not performed and the method proceeds from operation 212 back to operation 210. In other embodiments, operation 214 occurs before operation 212 or simultaneous with operation 212. Upon completion, the method 200 may return to operation 210 and proceed on to the subsequent operations. Supplementary data points may be the further data points received at operation 210 or some other data points.

### Example System Architecture

FIG. 8 shows a block diagram of an example system 300 capable for use with several embodiments of the present disclosure. As shown, the system 300 may include a number of different modules or components, each of which may comprise any device or means embodied in either hardware, software, or a combination of hardware and software configured to perform one or more corresponding functions. For example, the system 300 may include a marine electronics device 302 (e.g., controller) and various sensors/system.

The marine electronics device 302, controller, remote control, MFD, and/or user interface display may include a processor 304, a memory 312, a communication interface 314, a user interface 308, a display 310, and one or more sensors (e.g., other sensors 322, which may be in the marine electronics device 302 or otherwise operatively connected (e.g., wired or wirelessly)). In some embodiments, the processor 304 may include an autopilot navigation assembly 324.

The processor 304 may be in communication with one or more devices such as first propulsion device 330, second propulsion device 328, other propulsion device(s) 334, remote or other user input 320, sonar system 332, accelerometer 326, and/or other sensors 322 to control a speed and/or a direction of a watercraft (among other activities). For example, the processor 304 may receive user input or other instructions from the remote or other user input 320, from autopilot navigation 324, and/or from any other component such as remote device 316, and the processor 304 may use that received data to make a determination. In some embodiments, the received data may indicate an overall desired speed and/or direction for a watercraft, and the processor 304 may be used to determine instructions and/or input values to send to components such as the first propulsion device 330, the second propulsion device 328, and/or the other propulsion device(s) 334 to achieve an overall actual speed and/or direction of the watercraft that is equal to the overall desired speed and/or direction of the watercraft, as described herein. The remote or other user input 320 may include a joystick in some embodiments, and in other embodiments, the received data may be obtained through any other interface or mechanism. The processor 304 may use external data from other components such as the autopilot navigation 324, the memory 312, the remote device 316 (via the communication interface 314 and the external network 306), the accelerometer 326, the computing device 318, the sonar system 332, and/or the other sensors 322 to make such determinations, as described herein. For example, data from the accelerometer 326 may be used by the processor 304 to determine that the watercraft is operating under rough conditions, and the memory 312 may be used to determine that the first propulsion device 330 is a trolling motor that has risk of damage in rough conditions. In such case, the processor 304 might determine instructions that aim to avoid damaging the first propulsion device 330, as described herein with reference to FIG. 6.

The sonar system 332 may include one or more sonar transducer assembly(s), which may be any type of sonar transducer (e.g., a downscan transducer, a sidescan transducer, a transducer array (e.g., for forming live sonar), among many others known to one of ordinary skill in the art). The sonar transducer assembly(s) may be housed in the sonar system 332 and configured to gather sonar data from the underwater environment relative to the marine vessel. Accordingly, the processor 304 (such as through execution of computer program code) may be configured to adjust an orientation of the sonar transducer assembly(s) within the sonar system 332 and receive an indication of operation of the sonar transducer assembly(s). The processor 304 may generate additional display data indicative of the operation of the sonar transducer assembly(s) and cause the display data to be displayed on the display 310. For example, a sonar icon (not shown) may be energized to indicate that the sonar transducer assembly(s) is/are operating.

The processor 304 may be positioned within the marine electronics device 302 in some embodiments, as shown in FIG. 8, but in other embodiments, the processor 304 may be positioned anywhere else. For example, the processor 304 may be positioned within the remote or other user input 320, at a remote location, or within any other component shown in FIG. 8.

In some embodiments, the system 300 may be configured to receive, process, and display various types of marine data. In some embodiments, the system 300 may include one or more processors 304 and the memory 312. Additionally, the system 300 may include one or more components that are configured to gather marine data or perform marine features. In such a regard, the processor 304 may be configured to process the marine data and generate one or more images corresponding to the marine data for display on the screen that is integrated in the marine electronics device 302. Further, the system 300 may be configured to communicate with various internal or external components (e.g., through the communication interface 314), such as to provide instructions related to the marine data.

The processor 304 may be any means configured to execute various programmed operations or instructions stored in a memory, such as a device and/or circuitry operating in accordance with software or otherwise embodied in hardware or a combination thereof (e.g., a processor operating under software control, a processor embodied as an application specific integrated circuit (ASIC) or field programmable gate array (FPGA) specifically configured to perform the operations described herein, or a combination thereof) thereby configuring the device or circuitry to perform the corresponding functions of the processor 304 as described herein. In this regard, the processor 304 may be configured to analyze electrical signals communicated thereto to provide, e.g., display data to the display 310.

The memory 312 may be configured to store instructions, computer program code, marine data (e.g., sonar data, chart data, location/position data), and/or other data associated with the system 300 in a non-transitory computer readable medium for use by the processor, for example.

The system 300 may also include one or more communications modules configured to communicate via any of many known manners, such as via a network, for example. The processing circuitry and communication interface 314 may form a processing circuitry/communication interface. The communication interface 314 may be configured to enable connections to external systems (e.g., an external network 306 or one or more remote controls, such as a handheld remote control, marine electronics device, foot pedal, or other remote computing device). In this regard, the communication interface (e.g., 314) may include one or more of a plurality of different communication backbones or frameworks, such as Ethernet, USB, CAN, NMEA 2000, GPS, Sonar, cellular, Wi-Fi, and/or other suitable networks, for example. In this manner, the processor 304 may retrieve stored data from a remote, external server via the external network 306 in addition to or as an alternative to the onboard memory 312. The network may also support other data sources, including GPS, autopilot, engine data, compass, radar, etc. Numerous other peripheral, remote devices such as one or more wired or wireless multi-function displays may be connected to the system 300.

It should be appreciated that devices and/or systems such as the first propulsion device 330, the second propulsion device 328, the other propulsion device(s) 334, the remote or other user input 320, the sonar system 332, the accelerometer 326, the other sensors 322, and even other components, may, in some other embodiments, be in communication with a processor such as the processor 304 through a network such as the external network 306. That is, in some other embodiments, the first propulsion device 330, the second propulsion device 328, the other propulsion device(s) 334, the remote or other user input 320, the sonar system 332, the accelerometer 326, the other sensors 322, and even other components, may be in direct communication with a network that is connected to the processor 304 rather than being in direct communication with the processor 304 itself. In some other embodiments, the first propulsion device 330, the second propulsion device 328, the other propulsion device(s) 334, the remote or other user input 320, the sonar system 332, the accelerometer 326, the other sensors 322, and even other components, may be in direct communication with the processor 304 and may also be in direct communication with a network. Other configurations are also contemplated.

The processor 304 may configure the marine electronic device 302 and/or circuitry to perform the corresponding functions of the processor 304 as described herein. In this regard, the processor 304 may be configured to analyze electrical signals communicated thereto to provide, for example, various features/functions described herein.

In some embodiments, the system 300 may be configured to determine the location of the marine vessel, such as through a location sensor. The system 300 may comprise, or be associated with, a navigation system that includes the location sensor. For example, the location sensor may comprise a GPS, bottom contour, inertial navigation system, such as a micro-electro-mechanical system (MEMS) sensor, a ring laser gyroscope, or the like, or other location detection system. In such a regard, the processor 304 may be configured to act as a navigation system. For example, the processor 304 may generate at least one waypoint and, in some cases, generate an image of a chart along with the waypoint for display by the screen. Additionally or alternatively, the processor may generate one or more routes associated with the watercraft. The location of the vessel, waypoints, and/or routes may be displayed on a navigation chart on a display remote from the system 300. Further, additional navigation features (e.g., providing directions, weather information, etc.) are also contemplated.

In addition to position, navigation, and sonar data, example embodiments of the present disclosure contemplate receipt, processing, and generation of images that include other marine data. For example, the display 310 and/or user interface 308 may be configured to display images associated with vessel or motor status (e.g., gauges) or other marine data.

In any of the embodiments, the display 310 may be configured to display an indication of the current direction of the marine vessel.

The display 310 may be configured to display images and may include or otherwise be in communication with a user interface 308 configured to receive input from a user. The display 310 may be, for example, a conventional liquid crystal display (LCD), LED/OLED display, touchscreen display, mobile media device, and/or any other suitable display known in the art, upon which images may be displayed. In some embodiments, the display 310 may be the MFD and/or the user's mobile media device. The display may be integrated into the marine electronic device 302. In some example embodiments, additional displays may also be included, such as a touch screen display, mobile media device, or any other suitable display known in the art upon which images may be displayed.

In some embodiments, the display 310 may present one or more sets of marine data and/or images generated therefrom. Such marine data may include chart data, radar data, weather data, location data, position data, orientation data, sonar data, and/or any other type of information relevant to the marine vessel. In some embodiments, the display 310 may be configured to present marine data simultaneously as one or more layers and/or in split-screen mode. In some embodiments, the user may select various combinations of the marine data for display. In other embodiments, various sets of marine data may be superimposed or overlaid onto one another. For example, a route may be applied to (or overlaid onto) a chart (e.g., a map or navigation chart). Additionally, or alternatively, depth information, weather information, radar information, sonar information, and/or any other display inputs may be applied to and/or overlaid onto one another.

In some embodiments, the display 310 and/or user interface may be a screen that is configured to merely present images and not receive user input. In other embodiments, the display and/or user interface may be a user interface such that it is configured to receive user input in some form. For example, the screen may be a touchscreen that enables touch input from a user. Additionally, or alternatively, the user interface may include one or more buttons (not shown) that enable user input.

The user interface 308 may include, for example, a keyboard, keypad, function keys, mouse, scrolling device, input/output ports, touch screen, or any other mechanism by which a user may interface with the system.

In some embodiments, the system 300 may comprise an autopilot navigation 324 that is configured to operate the first propulsion device 330, the second propulsion device 328, the other propulsion device(s) 334, the remote or other user input 320, and/or the processor 304 directly to propel the marine vessel in a direction and at a speed. In some embodiments, the autopilot navigation 324 may direct the marine vessel to a waypoint (e.g., a latitude and longitude coordinate). Additionally, or alternatively, the autopilot may be configured to direct the marine vessel along a route, such as in conjunction with the navigation system. The processor 304 may generate display data based on the autopilot operating mode and cause an indication of the autopilot operating mode to be displayed on the digital display in the first portion, such as an autopilot icon. Further, the autopilot navigation 324 may be configured to provide information to the processor 304 that aids in instructions transmitted to the first propulsion device 330, the second propulsion device 328, and/or the other propulsion device(s) 334 (e.g., to achieve an optimal overall direction and/or speed of the watercraft, etc.).

In some embodiments, the sonar system 332 may be used to determine depth and bottom topography, detect fish, locate wreckage, etc. Sonar beams, from a sonar transducer assembly, can be transmitted into the underwater environment. The sonar signals reflect off objects in the underwater environment (e.g., fish, structure, sea floor bottom, etc.) and return to the sonar transducer assembly, which converts the sonar returns into sonar data that can be used to produce an image of the underwater environment.

In an example embodiment, the system 300 may include a speed sensor, such as an electromagnetic speed sensor, paddle wheel speed sensor, or the like. The speed sensor may be configured to measure the speed of the marine vessel through the water. The processor 304 may receive speed data from the speed sensor and generate additional display data indicative of the speed of the marine vessel through the water. The speed data may be displayed, such as in text format on the first portion of the digital display. The speed data may be displayed in any relevant unit, such as miles per hour, kilometers per hour, feet per minute, or the like. In some instances, a unit identifier, such as a plurality of LEDs, may be provided in association with the display (may be shown in normal text or with a seven-digit display). The processor 304 may cause an LED associated with the appropriate unit for the speed data to be illuminated.

In some embodiments, the system 300 further includes one or more power sources (e.g., batteries) that are configured to provide power to the various components. In some embodiments, a power source may be rechargeable. In some example embodiments, the system 300 includes one or more battery sensor(s). The battery sensor(s) may include one or more current sensors or voltage sensors configured to measure the current charges of battery power supplies of the system 300. The battery sensor(s) may be configured to measure individual battery cells or measure a battery bank. The processor 304 may receive battery data from the battery sensor(s) and determine the remaining charge on the battery or batteries. In an example embodiment, the voltages or currents measured by the battery sensor(s) may be compared to a reference value or data table, stored in memory 312, to determine the remaining charge(s) on the battery or batteries.

In some embodiments, the system 300 may include an accelerometer 326 for

measuring acceleration data, which may be logged by the processor 304. The acceleration data may be utilized, e.g., for detecting sudden unwanted movements of the watercraft (e.g., from hitting an obstacle), which could contribute, in some embodiments, to machine learning methods such as those described with respect to FIG. 7.

Implementations of various technologies described herein may be operational with numerous general purpose or special purpose computing system environments or configurations. Examples of well-known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, smart phones, tablets, wearable computers, cloud computing systems, virtual computers, marine electronics devices, and the like.

The various technologies described herein may be implemented in general context of computer-executable instructions, such as program modules, being executed by a computer. Generally, program modules may include routines, programs, objects, components, data structures, etc. that performs particular tasks or implement particular abstract data types. Further, each program module may be implemented in its own way, and all need not be implemented the same way. While program modules may all execute on a single computing system, it should be appreciated that, in some instances, program modules may be implemented on separate computing systems and/or devices adapted to communicate with one another. Further, a program module may be some combination of hardware and software where particular tasks performed by the program module may be done either through hardware, software, or both.

The various technologies described herein may be implemented in the context of marine electronics, such as devices found in marine vessels and/or navigation systems. Ship instruments and equipment may be connected to the computing systems described herein for executing one or more navigation technologies. As such, the computing systems may be configured to operate using sonar, radar, GPS and like technologies.

The various technologies described herein may also be implemented in distributed computing environments where tasks are performed by remote processing devices that are linked through a communications network (e.g., by hardwired links, wireless links, or combinations thereof). In a distributed computing environment, program modules may be located in both local and remote computer storage media including memory storage devices.

The system 300 may include a computing device or system 318 (e.g., mobile media device) into which implementations of various technologies and techniques described herein may be implemented. Computing device 318 may be a conventional desktop, a handheld device, a wearable device, a controller, a personal digital assistant, a server computer, an electronic device/instrument, a laptop, a tablet, or part of a navigation system, marine electronics, or sonar system. It should be noted, however, that other computer system configurations may be used.

In various implementations, each marine electronic device 302 described herein may be referred to as a marine device or as an MFD. The marine electronic device 302 may include one or more components disposed at various locations on a marine vessel. Such components may include one or more data modules, sensors, instrumentation, and/or any other devices known to those skilled in the art that may transmit various types of data to the marine electronic device 302 for processing and/or display. The various types of data transmitted to the marine electronic device 302 may include marine electronics data and/or other data types known to those skilled in the art. The marine data received from the marine electronic device 302 or system 300 may include chart data, sonar data, structure data, radar data, navigation data, position data, heading data, automatic identification system (AIS) data, Doppler data, speed data, course data, or any other type known to those skilled in the art.

In one implementation, the marine electronic device 302 may include a radar sensor for recording the radar data and/or the Doppler data, a compass heading sensor for recording the heading data, and a position sensor for recording the position data. In another implementation, the marine electronic device 302 may include a sonar transducer for recording the sonar data, an AIS transponder for recording the AIS data, a paddlewheel sensor for recording the speed data, and/or the like.

The marine electronic device 302 may receive external data via a LAN or a WAN. In some implementations, external data may relate to information not available from various marine electronics systems. The external data may be retrieved from various sources, such as, e.g., the Internet or any other source. The external data may include atmospheric temperature, atmospheric pressure, tidal data, weather, temperature, moon phase, sunrise, sunset, water levels, historic fishing data, and/or various other fishing and/or trolling related data and information.

The marine electronic device 302 may be attached to various buses and/or networks, such as a National Marine Electronics Association (NMEA) bus or network, for example. The marine electronic device 302 may send or receive data to or from another device attached to the NMEA 2000 bus. For instance, the marine electronic device 302 may transmit commands and receive data from a motor or a sensor using an NMEA 2000 bus. In some implementations, the marine electronic device 302 may be capable of steering a marine vessel and controlling the speed of the marine vessel (e.g., autopilot). For instance, one or more waypoints may be input to the marine electronic device 302, and the marine electronic device 302 may be configured to steer the marine vessel to the one or more waypoints. Further, the marine electronic device 302 may be configured to transmit and/or receive NMEA 2000 compliant messages, messages in a proprietary format that do not interfere with NMEA 2000 compliant messages or devices, and/or messages in any other format. In various other implementations, the marine electronic device 302 may be attached to various other communication buses and/or networks configured to use various other types of protocols that may be accessed via, e.g., NMEA 2000, NMEA 0183,Ethernet, Proprietary wired protocol, etc. In some implementations, the marine electronic device 302 may communicate with various other devices on the marine vessel via wireless communication channels and/or protocols.

In some implementations, the marine electronic device 302 may be connected to a global positioning system (GPS) receiver. The marine electronic device 302 and/or the GPS receiver may be connected via a network interface. In this instance, the GPS receiver may be used to determine position and coordinate data for a marine vessel on which the marine electronic device 302 is disposed. In some instances, the GPS receiver may transmit position coordinate data to the marine electronic device 302. In various other instances, any type of known positioning system may be used to determine and/or provide position coordinate data to/for the marine electronic device 302.

The marine electronic device 302 may be configured as a computing system similar to computing device 318.

### Example Flowchart(s)

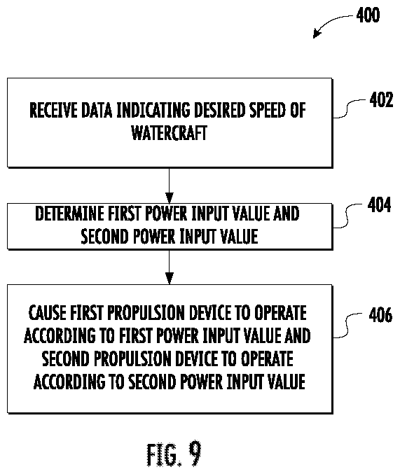

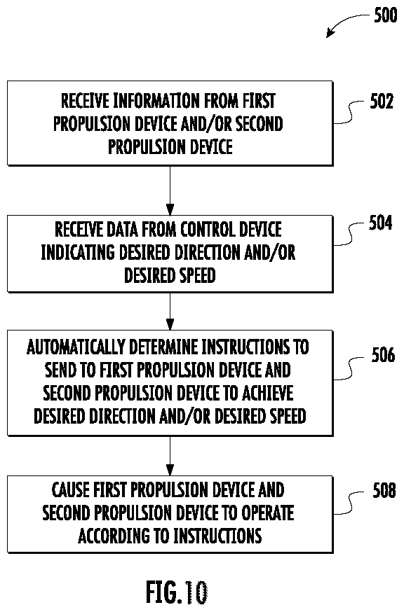

Embodiments of the present disclosure provide methods for controlling a watercraft. Various examples of the operations performed in accordance with embodiments of the present disclosure will now be provided with reference to FIGS. 9-10.

FIG. 9 illustrates a flowchart according to an example method 400 for controlling a speed of a watercraft, according to various example embodiments described herein. The operations illustrated in and described with respect to FIG. 9 may, for example, be performed by, with the assistance of, and/or under the control of one or more of the components described herein, e.g., in relation to system 300.

Operation 402 may comprise receiving data indicating a desired speed of the watercraft. In some embodiments, for example, operation 402 may include receiving data from a joystick, an autopilot navigation assembly, or any other user input interface or mechanism, among other ways. The components discussed above with respect to system 300 may, for example, provide means for performing operation 402.

Operation 404 may include determining a first power input value and a second power input value. For example, operation 404 may include determining a first power input value for a first propulsion device and a second power input value for a second propulsion device such that a predicted speed of the watercraft equals the desired speed of the watercraft. The first propulsion device may be configured to propel the watercraft, and the second propulsion device may also be configured to propel the watercraft, as described herein. In some embodiments, the first power input value may be a non-zero value, and the second power input value may also be a non-zero value. The predicted speed of the watercraft may correspond to when the first propulsion device is operating according to the first power input value and the second propulsion device is operating according to the second power input value. The components discussed above with respect to system 300 may, for example, provide means for performing operation 404.

Operation 406 may include causing the first propulsion device to operate according to the first power input value and the second propulsion device to operate according to the second power input value such that the watercraft achieves the desired speed. The components discussed above with respect to system 300 may, for example, provide means for performing operation 406.

FIG. 10 illustrates a flowchart according to an example method 500 for controlling a watercraft, according to various example embodiments described herein. The operations illustrated in and described with respect to FIG. 10 may, for example, be performed by, with the assistance of, and/or under the control of one or more of the components described herein, e.g., in relation to system 300.

Operation 502 may include receiving information from a first propulsion device and/or a second propulsion device. In some embodiments, for example, operation 502 may include receiving first data from the first propulsion device indicating a first direction of the first propulsion device, a first detected revolutions per minute value of the first propulsion device, and/or a first status of the first propulsion device. Operation 502 may also include receiving second data from the second propulsion device indicating a second direction of the second propulsion device, a second detected revolutions per minute value of the second propulsion device, and/or a second status of the second propulsion device. Operation 502 may also include receiving additional data from the first propulsion device, the second propulsion device, a marine electronics device on the watercraft, and/or a remote server. The components discussed above with respect to system 300 may, for example, provide means for performing operation 502. Operation 502 may be optional.

Operation 504 may include receiving data from a control device indicating a desired direction and/or speed of the watercraft. In some embodiments, for example, operation 504 may include receiving data from a joystick indicating the desired direction and/or speed of the watercraft. The components discussed above with respect to system 300 may, for example, provide means for performing operation 504.

Operation 506 may include automatically determining instructions to send to the first propulsion device and the second propulsion device to achieve the desired direction and/or speed. The first instructions and the second instructions may be such that the watercraft as a whole travels at the desired direction and/or speed when the first propulsion device operates according to the first instructions and the second propulsion device operates according to the second instructions. In some embodiments, for example, operation 506 may include determining first instructions that include a first vector associated with a first propulsion device and determining second instructions that include a second vector associated with a second propulsion device. The components discussed above with respect to system 300 may, for example, provide means for performing operation 506.

Operation 508 may include causing the first propulsion device and the second propulsion device to operate according to the instructions. In some embodiments, for example, operation 508 may include causing the first propulsion device to operate in accordance with the first vector and causing the second propulsion device to operate in accordance with the second vector, as described herein. The components discussed above with respect to system 300 may, for example, provide means for performing operation 508.

FIGS. 9-10 illustrate flowcharts of systems, methods, and/or computer program products according to example embodiments. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by, for example, the memory 312, and executed by, for example, the processor 304. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more non-transitory computer-readable mediums on which the computer program instructions may be stored such that the one or more computer-readable memories can direct a computer or other programmable device to cause a series of operations to be performed on the computer or other programmable apparatus to produce a computer-implemented process such that the instructions which execute on the computer or other programmable apparatus implement the functions specified in the flowchart block(s).

In some embodiments, the methods for controlling a watercraft may include additional, optional operations, and/or the operations described above may be modified or augmented.

### Conclusion

Many modifications and other embodiments of the inventions set forth herein may come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

1. A system for controlling a speed of a watercraft, the system comprising:
a first propulsion device configured to propel the watercraft;
a second propulsion device configured to propel the watercraft;
a processor; and
a memory including computer program code configured to, when executed, cause the processor to:
receive data indicating a desired speed of the watercraft;
determine a first power input value for the first propulsion device and a second power input value for the second propulsion device such that a predicted speed of the watercraft equals the desired speed of the watercraft, wherein the first power input value is a non-zero value, wherein the second power input value is a non-zero value, wherein the predicted speed of the watercraft corresponds to when the first propulsion device is operating according to the first power input value and the second propulsion device is operating according to the second power input value; and
cause the first propulsion device to operate according to the first power input value and the second propulsion device to operate according to the second power input value such that the watercraft achieves the desired speed.

2. The system of claim 1, wherein the first propulsion device is a trolling motor.

3. The system of claim 2, wherein the second propulsion device is an outboard or an inboard motor.

4. The system of claim 1, wherein the system further comprises a third propulsion device, and wherein the processor is further configured to:
determine the first power input value for the first propulsion device, the second power input value for the second propulsion device, and a third power input value for the third propulsion device such that the predicted speed of the watercraft equals the desired speed of the watercraft, wherein the predicted speed of the watercraft corresponds to when the first propulsion device is operating according to the first power input value, the second propulsion device is operating according to the second power input value, and the third propulsion device is operating according to the third power input value; and
cause the first propulsion device to operate according to the first power input value, the second propulsion device to operate according to the second power input value, and the third propulsion device to operate according to the third power input value such that the watercraft achieves the desired speed.

5. The system of claim 4, wherein the third propulsion device is a thruster.

6. The system of claim 1, wherein the data indicating the desired speed of the watercraft comes from at least one of a remote, a wired or wireless joystick, or a mobile device.

7. The system of claim 1, wherein the processor is further configured to at least one of:
receive first data from the first propulsion device indicating at least one of a first direction of the first propulsion device, a first detected revolutions per minute value of the first propulsion device, or a first status of the first propulsion device;
receive second data from the second propulsion device indicating at least one of a second direction of the second propulsion device, a second detected revolutions per minute value of the second propulsion device, or a second status of the second propulsion device; or
receive additional data from at least one of the first propulsion device, the second propulsion device, a marine electronics device on the watercraft, or a remote server.

8. The system of claim 7, wherein the first status is at least one of a first on/off status or a first operating mode, and wherein the second status is at least one of a second on/off status or a second operating mode.

9. The system of claim 7, wherein the processor is further configured to:
use at least one of the first data, the second data, or the additional data to determine the first power input value for the first propulsion device and the second power input value for the second propulsion device.

10. The system of claim 9, wherein the processor is further configured to use at least one of the first data, the second data, or the additional data to determine at least one of a first new direction for the first propulsion device or a second new direction for the second propulsion device.

11. The system of claim 10, wherein the processor is further configured to use machine learning methods for at least one of:
determining the first power input value for the first propulsion device and the second power input value for the second propulsion device; or
determining at least one of the first new direction for the first propulsion device or the second new direction for the second propulsion device.

12. The system of claim 9, wherein the additional data includes at least one of battery life data for at least one of the first propulsion device or the second propulsion device, depth data, tide data, wind data, weather data, boat profile data, or user defined data.

13. The system of claim 1, wherein the processor is further configured to:
detect a partial loss or a full loss of output in at least one of the first propulsion device or the second propulsion device; and
dynamically update the first power input value for the first propulsion device and the second power input value for the second propulsion device such that the watercraft maintains the desired speed.

14. The system of claim 1, wherein the data indicating the desired speed of the watercraft includes at least one of user input, a signal from an autopilot navigation assembly, or a signal from the processor.

15. The system of claim 1, wherein the processor is further configured to:
determine a mode in which the watercraft is operating; and
use the mode to determine the first power input value for the first propulsion device and the second power input value for the second propulsion device.

16. The system of claim 15, wherein the mode is at least one of a fishing mode, a cruising mode, a trolling mode, a docking mode, a rough conditions mode, a low battery mode, a low fuel mode, or a customized mode.

17. The system of claim 1, wherein the processor is further configured to:
receive data indicating a desired direction of the watercraft;
determine first instructions comprising a first vector associated with the first propulsion device;
determine second instructions comprising a second vector associated with the second propulsion device;
cause the first propulsion device to operate according to the first instructions, wherein the first vector corresponds to the first power input value such that causing the first propulsion device to operate according to the first instructions also causes the first propulsion device to operate according to the first power input value; and
cause the second propulsion device to operate according to the second instructions, wherein the second vector corresponds to the second power input value such that causing the second propulsion device to operate according to the second instructions also causes the second propulsion device to operate according to the first power input value.

18. The system of claim 17, wherein the first instructions comprising the first vector include a first direction and the first power input value, and wherein the second instructions comprising the second vector include a second direction and the second power input value, and wherein the first instructions and the second instructions are determined such that the watercraft as a whole travels at the desired speed and in the desired direction when the first propulsion device operates according to the first instructions and the second propulsion device operates according to the second instructions.

19. A method for controlling a speed of a watercraft, the method comprising:
receiving data indicating a desired speed of the watercraft;
determining a first power input value for a first propulsion device and a second power input value for a second propulsion device such that a predicted speed of the watercraft equals the desired speed of the watercraft, wherein the first propulsion device is configured to propel the watercraft, wherein the second propulsion device is configured to propel the watercraft, wherein the first power input value is a non-zero value, wherein the second power input value is a non-zero value, wherein the predicted speed of the watercraft corresponds to when the first propulsion device is operating according to the first power input value and the second propulsion device is operating according to the second power input value; and
causing the first propulsion device to operate according to the first power input value and the second propulsion device to operate according to the second power input value such that the watercraft achieves the desired speed.

20. A system for controlling a watercraft, the system comprising:
a first propulsion device configured to propel the watercraft;
a second propulsion device configured to propel the watercraft;
a control device configured to control at least one of an actual speed or an actual direction of the watercraft by communicating with at least the first propulsion device and the second propulsion device;
a processor; and
a memory including computer program code configured to, when executed, cause the processor to:
receive information from at least one of the first propulsion device or the second propulsion device including at least one of:
one or more of a first direction of the first propulsion device and a second direction of the second propulsion device;
one or more of a first revolutions per minute value of the first propulsion device and a second revolutions per minute value of the second propulsion device; or
one or more of a first status of the first propulsion device and a second status of the second propulsion device;
receive data from the control device indicating at least one of a desired direction or a desired speed of the watercraft;
automatically determine instructions to send to each of the first propulsion device and the second propulsion device to achieve the at least one of the desired direction or the desired speed of the watercraft; and
cause the first propulsion device and the second propulsion device to operate according to the instructions such that the at least one of the actual speed or the actual direction of the watercraft is equal to the at least one of the desired speed or the desired direction of the watercraft, respectively.

21. A method for controlling a watercraft, the method comprising:
receiving information from at least one of a first propulsion device or a second propulsion device, wherein the first propulsion device is configured to propel the watercraft, wherein the second propulsion device is configured to propel the watercraft, and wherein the information includes at least one of:
one or more of a first direction of the first propulsion device and a second direction of the second propulsion device;
one or more of a first revolutions per minute value of the first propulsion device and a second revolutions per minute value of the second propulsion device; or
one or more of a first status of the first propulsion device and a second status of the second propulsion device,
receiving data from a control device indicating at least one of a desired direction or a desired speed of the watercraft, wherein the control device is configured to control at least one of an actual speed or an actual direction of the watercraft by communicating with at least the first propulsion device and the second propulsion device;
automatically determining instructions to send to each of the first propulsion device and the second propulsion device to achieve the at least one of the desired direction or the desired speed of the watercraft; and
causing the first propulsion device and the second propulsion device to operate according to the instructions such that the at least one of the actual speed or the actual direction of the watercraft is equal to the at least one of the desired speed or the desired direction of the watercraft, respectively.

22-40. (canceled)
